(19) United States
(12) Patent Application Publication
(10) Pub. No.: US 2012/0179739 A1
(43) Pub. Date: Jul. 12, 2012

(54) METHOD, APPARATUS, AND SYSTEM FOR PROCESSING TIME

(75) Inventors: Fang Ji, Nanjing (CN); Wei Yan, Nanjing (CN)

(73) Assignee: Huawei Technologies Co., Ltd., Shenzhen (CN)

(21) Appl. No.: 13/406,292

(22) Filed: Feb. 27, 2012

Related U.S. Application Data
(63) Continuation of application No. PCT/CN2010/076386, filed on Aug. 26, 2010.

(30) Foreign Application Priority Data
Aug. 27, 2009 (CN) 200910171246.4

(51) Int. Cl. G06F 15/16

(52) U.S. Cl. 709/201

(57) ABSTRACT

A method, an apparatus, and a system for processing time are disclosed. The method includes: converting local time in an operation request from a user in any time zone to unified time, and forwarding the operation request to a back end for processing; and converting the unified time in an operation result of the back end to local time, and returning the operation result to the user. In the embodiments of the present invention, the front end apparatus performs conversion between the displayed local time and the unified time of the back end apparatus, which ensures real-time updating of the local time. Therefore, the front end apparatus responds to time change quickly, without the need of changing time synchronously with the back end apparatus; and the impact caused by time on the processing of bills, logs and reports is overcome.

### CROSS-REFERENCE TO RELATED APPLICATIONS

This application is a continuation of International Application No. PCT/CN2010/076386, filed on Aug. 26, 2010, which claims priority to Chinese Patent Application No. 200910171246.4, filed on Aug. 27, 2009, both of which are hereby incorporated by reference in their entireties.

### TECHNICAL FIELD

The present invention relates to the field of information processing technologies, and in particular, to a method, an apparatus, and a system for processing time.

### BACKGROUND

Daylight saving time is also known as daylight saving time (Daylight Saving Time), and is a system for stipulating regional time intentionally to save energy. The unified time in a period of practicing such a system is called “daylight saving time”. Generally, in the summer days with early dawns, the time is advanced by one hour intentionally so that people go to bed early and get up early. In this way, use of electric light is reduced, solar light is fully used, and power is saved. The countries that apply the daylight saving time stipulate the daylight saving time differently. At present, nearly 110 countries in the world apply the daylight saving time every year. Therefore, most countries in the world have different time zones and different start time of the daylight saving time system. This problem brings an adverse impact on the systems that cross different time zones. Similarly, a winter time system may be used, depending on different requirements.

In the prior art, a server in a system includes two important modules: a database of daylight saving time rules and time zones (DST rules and Time Zone Database), and a conversion engine. The database of daylight saving time rules and time zones stores the time zones in which different clients are located, and daylight saving time in such time zones. According to the time zones in which different clients are located and the daylight saving time of the countries in which the clients are located, the conversion engine adjusts and converts the time. Through such adjustment, the system displays time properly. However, when the system includes multiple servers deployed in different time zones in which different daylight saving time systems or winter time systems are practiced, the time of the multiple servers is improper, and reports and logs display the system time improperly.

### SUMMARY

Embodiments of the present invention solve the time problem of multiple servers in the existing time zone system and the problem of displaying system time in reports and logs.

An embodiment of the present invention provides a time processing method, including: converting local time in an operation request from a user in any time zone to unified time, and forwarding the operation request to a back end for processing; and converting the unified time in an operation result of the back end to the local time, and returning the operation result to the user.

An embodiment of the present invention provides a time processing apparatus, including: a client unit, configured to receive an operation request from a user in any time zone and return an operation result to the user, where the operation request and the operation result include a time condition of using local time; a server unit, configured to convert the time condition in the operation request from the local time to unified time, forward the converted operation request to a back end for processing, receive the operation result from the back end, and convert the time condition in the operation result from the unified time to the local time; and a storage unit, configured to store local time rules and time zone information.

An embodiment of the present invention provides a time processing apparatus, including: a client unit, configured to receive an operation request from a user in any time zone and return an operation result to the user, where the operation request and the operation result include a time condition of using local time; a time proxy unit, configured to convert the time condition in the operation request from the local time to unified time, and convert the time condition in the operation result from the unified time to the local time; a server unit, configured to forward the converted operation request to a back end for processing, and receive the operation result from the back end; and a storage unit, configured to store local time rules and time zone information.

An embodiment of the present invention provides a time processing system, including: multiple front end processing apparatuses, which respectively apply local time of different time zones and are respectively configured to receive an operation request from a user, convert a time condition in the operation request from the local time to unified time, forward the converted operation request to a back end processing apparatus, receive an operation result from the back end processing apparatus, convert the time condition in the operation result from the unified time to the local time, and return the converted operation result to the user; and multiple back end processing apparatuses, which correspond to the multiple front end processing apparatuses respectively, apply the unified time, and process the converted operation request.

In the embodiments of the present invention, the front end apparatus performs conversion between the displayed local time and the unified time of the back end apparatus, which ensures real-time updating of the local time. Therefore, the front end apparatus responds to time change quickly, without the need of changing time synchronously with the back end apparatus; and the impact caused by different time rules or time zones onto the processing of bills, logs and reports is overcome.

### BRIEF DESCRIPTION OF THE DRAWINGS

To make the technical solutions in the embodiments of the present invention or in the prior art clearer, the accompanying drawings for illustrating the embodiments of the present invention or the prior art are briefly described hereunder. Evidently, the accompanying drawings illustrate only some exemplary embodiments of the present invention, and persons skilled in the art can derive other drawings from such accompanying drawings without any creative effort.

FIG. 1 is a flowchart of a time processing method according to a first embodiment of the present invention;

FIG. 2 is a flowchart of a time processing method according to a second embodiment of the present invention;

FIG. 3 is a schematic structural diagram of a time processing apparatus according to a third embodiment of the present invention;

FIG. 4 is a schematic structural diagram of a server unit in a time processing apparatus according to a third embodiment of the present invention;

FIG. 5 is a schematic structural diagram of a time processing apparatus according to a fourth embodiment of the present invention;

FIG. 6 is a schematic structural diagram of a time processing system according to a fifth embodiment of the present invention; and

FIG. 7 is a schematic structural diagram of a time processing system according to a sixth embodiment of the present invention.

### DETAILED DESCRIPTION

To make the objectives, technical solutions, and merits of the present invention clearer, the following describes the embodiments of the present invention in detail with reference to the accompanying drawings. The exemplary embodiments of the present invention and the description of the embodiments are illustrative in nature, and shall not be construed as a limitation on the present invention.

### Embodiment 1

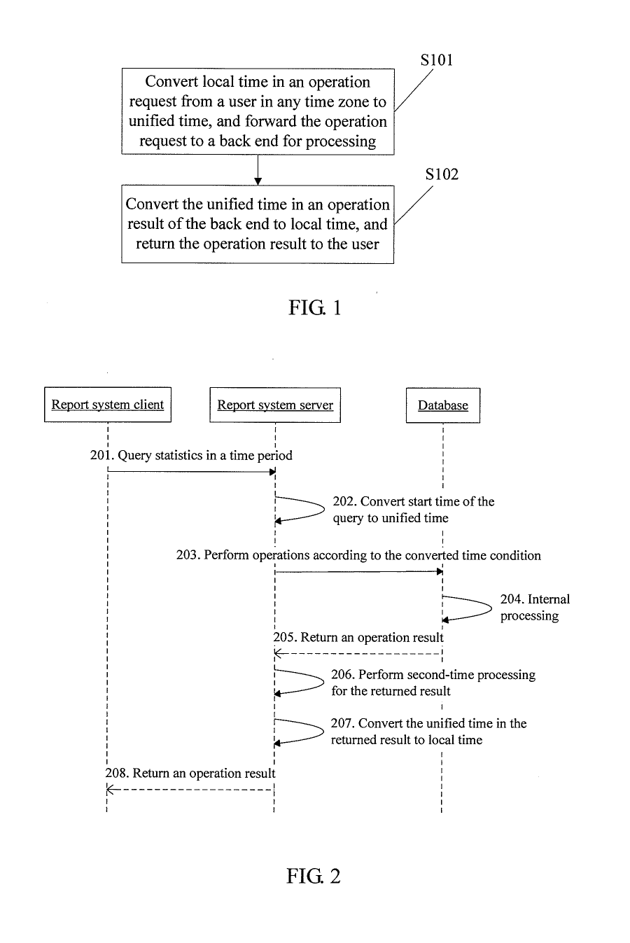

This embodiment provides a time processing method. As shown in FIG. 1, the method includes the following steps:

Step S101: Convert local time in an operation request from a user in any time zone to unified time, and forward the operation request to a back end for processing.

This step is generally performed by a front end apparatus. The operation request is sent by a client according to an operation condition input by a user. When receiving the operation request, a server converts local time in the operation request to unified time applied on a back end apparatus, and applies the unified time to all actions that involve recording of the current time, for example, actions of recording logs and bills. The unified time may be, but is not limited to, Universal Time Coordinated (UTC, Universal Time Coordinated). The client of the front end apparatus sends the operation request according to the condition input by a user in any time zone, in which the operation request includes a time condition of using the local time. When receiving the operation request, the client of the front end apparatus converts the local time to the unified time used by the back end apparatus, such as UTC time, and then sends the converted operation request to the back end apparatus.

Step S102: Convert the unified time in an operation result of the back end to the local time, and return the operation result to the user.

This step is still performed by the front end apparatus. The front end apparatus receives the operation result obtained after the back end apparatus performs an operation according to the operation request. The operation result includes the time condition of using the unified time. The server of the front end apparatus converts the unified time in the operation result to local time, and returns the operation result to the client of the front end apparatus.

In this embodiment, unified time is used on the back end apparatus to process data, local time on the front end apparatus is used to display the data, and the time is converted between the back end apparatus and the front end apparatus, which prevents the daylight saving time, winter time, and different time zones from affecting system-level operation requirements such as bills, logs, and reports on multiple front end servers.

### Embodiment 2

This embodiment provides another time processing method. As shown in FIG. 2, the method includes the following steps:

Step S201: According to a condition input by a user in any time zone, the client of a front end apparatus sends an operation request for querying statistics. The operation request includes a time condition of using local time, for example, includes start time and end time.

Step S202: When receiving the operation request, the server of the front end apparatus converts the start time and end time from the local time to unified time used by a back end apparatus, such as UTC time.

Step S203: The server of the front end apparatus sends the converted operation request to the back end apparatus.

Step S204: When receiving the operation request, the back end apparatus queries a database according to the unified time to obtain statistics.

Step S205: The back end apparatus returns the statistics to the server of the front end apparatus.

Step S206: The server of the front end apparatus performs second-time processing on the operation result returned by the back end apparatus.

Step S207: The server of the front end apparatus converts the unified time in the returned statistics to the local time.

Step S208: The server of the front end apparatus returns the statistics to the client of the front end apparatus.

Second-time processing refers to various possible operations, for example, consolidating data of multiple back ends such as a billing system. The statistics returned by multiple back end apparatuses form report data after the statistics are analyzed and consolidated. As regards bills, multiple back end devices return respective bills, and the front end server needs to analyze each bill again, analyze bills of all devices for a same call, and consolidate the bills to form a final bill.

In this embodiment, conversion is performed between the unified time of the back end apparatus and the local time of the front end apparatus, which prevents the daylight saving time, winter time, and different time zones from affecting system-level operation requirements such as bills, logs, and reports on multiple servers.

### Embodiment 3

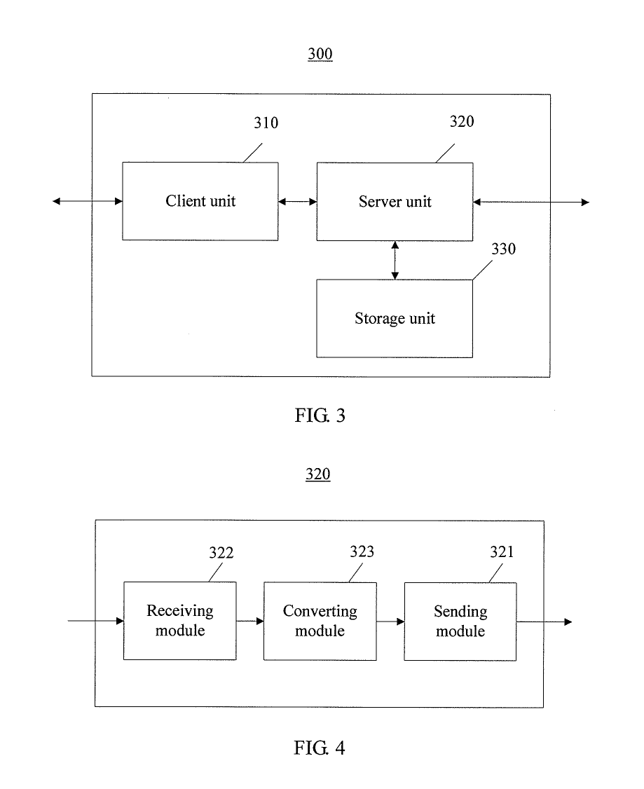

This embodiment provides a time processing apparatus. As shown in FIG. 3, the apparatus 300 includes:

a client unit 310, configured to receive an operation request from a user in any time zone and return an operation result to the user, where the operation request and the operation result include a time condition of using local time;

a server unit 320, configured to convert the time condition in the operation request from the local time to unified time, forward the converted operation request to a back end for processing, receive the operation result from the back end, and convert the time condition in the operation result from the unified time to the local time; and
a storage unit 330, configured to store local time rules and/or time zone information, where the time rules include daylight saving time rules, winter time rules, and time zone conversion rules.

As shown in FIG. 4, the server unit 320 includes:

a sending module 321, configured to send the operation request to the back end for processing;
a receiving module 322, configured to receive the operation result from the back end; and
a converting module 323, configured to convert the time condition in the operation request from the local time to the unified time, and convert the time condition in the operation result from the unified time to the local time.

The server unit 320 may further include a processing module configured to perform second-time processing on the operation result.

The storage unit 330 is any medium capable of storing local daylight saving-time rules or winter time rules, and/or time zone information, such as a database or configuration file. Although the time zone corresponding to local time is constant, the daylight saving time or winter time is variable. Therefore, a static configuration file is recommended as the medium for storing the local time zone information and daylight saving time or winter time information. The configuration file is easily maintainable, easily revisable, and replaceable. The following is an instance of a configuration file:

<?xml version=“1.0” encoding=“iso-8859-1”?>
<dummy name=“dummy”>
<tzdst name=“tzdst”>
<param name=“TZ”>GMT+8:00</param>
//indicates time zone information, in the format of

GMT{+|−}Hh:Mm, such as GMT in east time zone 8 + 08:00.

<param name=“StartDateAndTime”>20081020090909</param>
//GMT start time of daylight saving time or winter time, in

the format of yyyyMMddhhmmss, such as 20081020090909.

<param name=“EndDateAndTime”>20081220090909</param>
//GMT end time of daylight saving time or winter time, in

the format of yyyyMMddhhmmss, such as 20081220090909.

<param name=“DSTOffset”>+0:00</param>
//indicates an offset of daylight saving time or winter time,

in the format of {+|−}Hh:Mm, such as +01:00 (1 hour offset).

</tzdst>
</dummy>

With the apparatus in this embodiment, conversion is performed between the unified time of the back end apparatus and the local time of the front end apparatus, which prevents the daylight saving time, winter time, and different time zones from affecting system-level operation requirements such as bills, logs, and reports on multiple servers.

### Embodiment 4

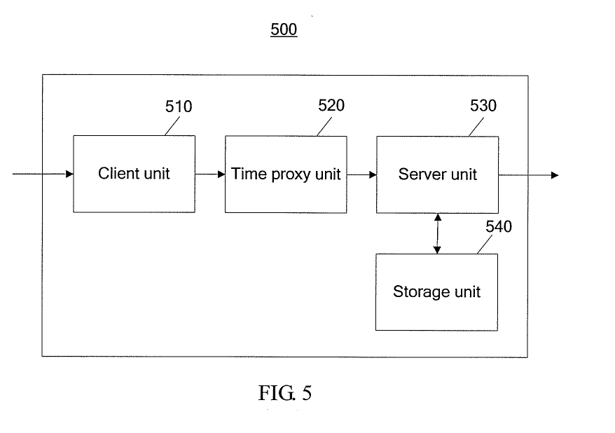

This embodiment provides another time processing apparatus. As shown in FIG. 5, the apparatus 500 includes:

a client unit 510, configured to receive an operation request from a user in any time zone and return an operation result to the user, where the operation request and the operation result include a time condition of using local time;

a time proxy unit 520, configured to convert the time condition in the operation request from the local time to unified time, and convert the time condition in the operation result from the unified time to the local time;

a server unit 530, configured to forward the converted operation request to a back end for processing, and receive the operation result from the back end; and

a storage unit 540, configured to store local time rules and/or time zone information, where the time rules may include daylight saving time rules or winter time rules.

The time proxy unit 520 is set between the server unit 530 and the client unit 510 to implement the function of converting the time condition in the operation request from the local time to the unified time and converting the time condition in the operation result from the unified time to the local time.

In certain scenarios, a time proxy may be set between the client of the front end apparatus and the server in the entire system that crosses time zones. The time proxy needs to be capable of synchronizing time with clocks in multiple time zones, which involves higher complexity but lower costs.

In this embodiment, the use of a time proxy reduces complexity of the server unit greatly, and the time conversion function of each component is abstracted and undertaken by a dedicated time proxy, which reduces system complexity and reduces costs.

### Embodiment 5

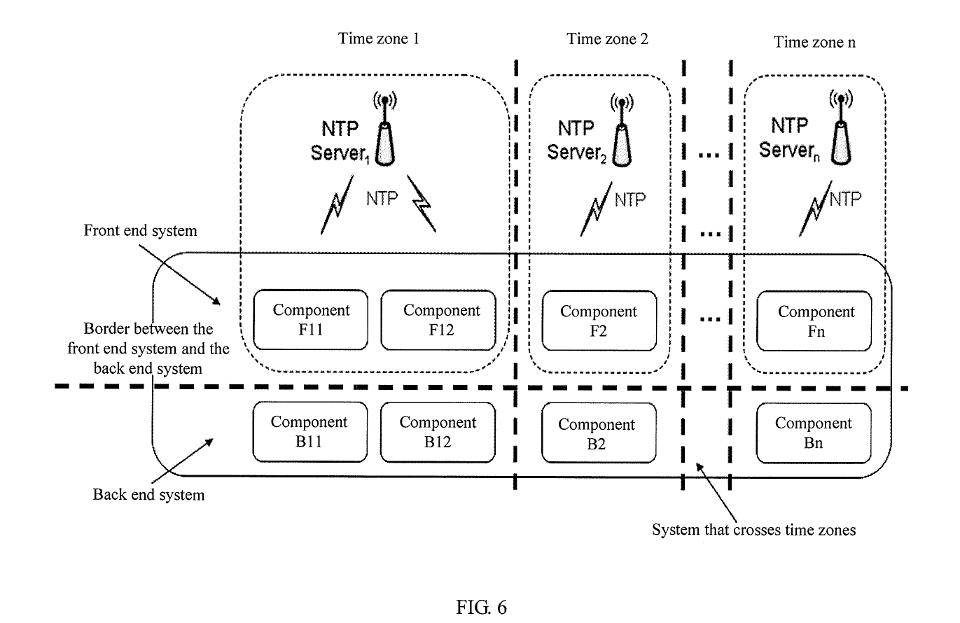

This embodiment provides a time processing system. As shown in FIG. 6, the system includes:

a front end system, which includes multiple front end processing apparatuses (NTP, Network Time Protocol, server 1, NTP server 2, . . . , NTP server n), where each of the front end processing apparatuses applies local time of different time zones (including components F11 and F12 corresponding to time zone 1, component F2 corresponding to time zone 2, . . . , component Fn corresponding to time zone n) and is configured to receive an operation request from a user, convert a time condition in the operation request from local time to unified time, forward the converted operation request to a back end processing apparatus, receive an operation result from the back end processing apparatus, convert the time condition in the operation result from the unified time to the local time, and return the converted operation result to the user; and
a back end system, which includes multiple back end processing apparatuses, where each of the back end processing apparatuses corresponds to one of the multiple front end processing apparatuses (including B11 and B12 corresponding to component F11 and component F12, component B2 corresponding to component F2, and Bn corresponding to component n), applies the unified time, and processes the converted operation request.

The front end apparatus is an apparatus that needs to display data at the front end, and the back end apparatus is an apparatus that runs at the back end to provide services. In time zone 1, the time of the front end component F11 and F12 remains synchronized to the time of NTP Server 1; the time of the front end component F2 remains synchronized to the time of NTP Server 2; and the time of the front end component Fn remains synchronized to the time of NTP Server n. In this way, the front end components can display the local time of the corresponding time zone. All the back end apparatuses need to use the unified time as the time of the running state. That is, the unified time is applied to all actions that involve recording of the current time, for example, actions of recording logs and bills. The unified time may be, but is not limited to, UTC time.

In this embodiment, the back end apparatuses use unified time, which ensures effective and accurate running of the system and prevents the system from being affected by the daylight saving time, winter time, or different time zones; the front end apparatus performs conversion between the displayed local time and the unified time of the back end, which ensures real-time updating of the local time and fast response to the change of the daylight saving time, winter time, or time zones, without the need of changing time synchronously with the back end apparatus; and this embodiment prevents the daylight saving time, winter time, and different time zones from affecting system-level operation requirements such as bills, logs, and reports on multiple servers.

### Embodiment 6

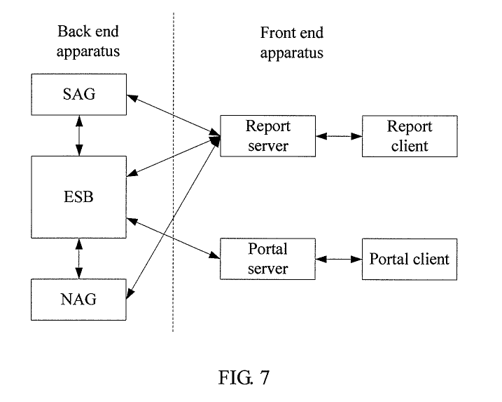

Taking a billing system as an example, this embodiment provides more details about the time system disclosed in the fifth embodiment, as shown in FIG. 7.

A service delivery platform (SDP, Service Delivery Platform) solution system involves multiple countries in different time zones. As shown in FIG. 7, the SDP system is deployed in different countries such as country A, country B, and country C in different time zones. The SDP system includes front end apparatuses and back end apparatuses; the front end apparatuses include a report server and a Portal server; and the back end apparatuses include an enterprise service bus (ESB, Enterprise Service Bus), a service access gateway (SAG, Service Access Gateway), and a network access gateway (NAG, Network Access Gateway). The SAG is configured to control the request for accessing the SDP platform; the ESB is a message bus inside the SDP platform, and all requests pass through the ESB; the NAG is a protocol conversion gateway responsible for conversion between SOAP messages and various protocols messages of a customer's telecom equipment. The SAG and the NAG are connected to the ESB through a SOAP interface. The servers of the front end apparatus include a report server and a Portal server, which are connected to a report client and a Portal client through a SOAP interface respectively. The report server and the Portal server are service logic processing modules, and parse the time fields involved in request messages, invoke an interface of a time converting module, obtain UTC time, and substitute the UTC time for the time in the original request. The report server is connected to the NAG, ESB, and SAG through an FTP/SFTP interface; and the Portal server is connected to the ESB through a SOAP interface, and sends the request message that includes the converted time to the back end apparatus. When returning a response, the report server and the Portal server convert the UTC time to client time, and send the response to the client.

The billing system and the administrator Portal involve man-machine interaction, and therefore, their display interfaces need to display the local time. The back end system uses UTC time uniformly to ensure time consistency of statistics of the entire SDP solution system and prevent the time change from affecting the running of all systems.

When an operation engineer in country B logs in to the report server in country B to obtain report information, an operation engineer in country A logs in to the report server in country A to obtain report information, and an operation engineer in country C logs in to the report server in country C to obtain report information, they are located in different time zones, and they input the statistical time point information according to respective local time. The local report server needs to convert the local time to UTC time to analyze and process the report information because the report information generated by different back end systems uses the UTC time.

Also, the administrator Portal is deployed in different countries, and displays the local time of each country. Therefore, the time involved in the relevant operation of the administrator needs to be converted in the same way as described above.

In this embodiment, the back end apparatuses use unified time, which ensures effective and accurate running of the billing system and prevents the system from being affected by the daylight saving time, winter time, or different time zones; the front end apparatus performs conversion between the displayed local time and the unified time of the back end, which ensures real-time updating of the local time and fast response to the change of the daylight saving time, winter time, or time zones, without the need of changing time synchronously with the back end apparatus; this embodiment prevents the daylight saving time, winter time, and different time zones from affecting system-level operation requirements of the billing systems on multiple servers.

The objectives, technical solutions, and benefits of the present invention have been described in detail with reference to the foregoing embodiments. It is understandable that the embodiments are only exemplary and not intended to limit the protection scope of the present invention. Any modifications, substitutions, and improvements made thereto without departing from the spirit and scope of the invention shall fall within the protection scope of the invention.

What is claimed is:

1. A time processing method, comprising:
converting local time in an operation request from a terminal of a user in any time zone to unified time, and forwarding the operation request to a back end for processing; and
converting the unified time in an operation result of the back end to local time, and returning the operation result to the terminal of the user.

2. The method according to claim 1, further comprising:
performing second-time processing on the operation result, wherein the second-time processing comprises: analyzing and consolidating data to form report data, or analyzing a bill to form a final bill.

3. The method according to claim 1, wherein:
the unified time comprises UTC, Universal Time Coordinated, time.

4. A time processing apparatus, comprising:
a client unit, configured to receive an operation request from a terminal of a user in any time zone and return an operation result to the terminal of the user, wherein the operation request and the operation result comprise a time condition of using local time;
a server unit, configured to convert the time condition in the operation request from the local time to unified time, forward the operation request with the converted time condition to a back end for processing, receive the operation result from the back end, and convert the time condition in the operation result from the unified time to the local time; and
a storage unit, configured to store a local time rule and/or time zone information.

5. The apparatus according to claim 4, wherein:
the time rule is a daylight saving time rule or a winter time rule.

6. The apparatus according to claim 4, wherein the server unit comprises:
a sending module, configured to send the operation request to the back end for processing;
a receiving module, configured to receive the operation result from the back end; and
a converting module, configured to convert the time condition in the operation request from the local time to the unified time, and convert the time condition in the operation result from the unified time to the local time.

7. The apparatus according to claim 6, wherein the server unit further comprises:
a processing module, configured to perform second-time processing on the operation result, wherein the second-time processing comprises: analyzing and consolidating data to form report data, or analyzing a bill to form a final bill.

8. A time processing apparatus, comprising:
a client unit, configured to receive an operation request from a terminal of a user in any time zone and return an operation result to the terminal of the user, wherein the operation request and the operation result comprise a time condition of using local time;
a time proxy unit, configured to convert the time condition in the operation request from the local time to unified time, and convert the time condition in the operation result from the unified time to the local time;
a server unit, configured to forward the converted operation request to a back end for processing, and receive the operation result from the back end; and
a storage unit, configured to store a local time rule and/or time zone information.

9. The apparatus according to claim 8, wherein:
the time rule is a daylight saving time rule and/or a winter time rule.
